(19) United States
(12) Patent Application Publication
(10) Pub. No.: US 2012/0233218 A1
(43) Pub. Date: Sep. 13, 2012

(54) System and Method for Delivering Brand Reinforcement as a Component of a Human Interactive Proof

(76) Inventor: Christopher Liam Ivey, Ottawa (CA)

(21) Appl. No.: 13/044,374

(22) Filed: Mar. 9, 2011

(51) Int. Cl. G06F 17/30

(52) U.S. Cl. 707/794; 707/E17.099

(57) ABSTRACT

A system and method for delivering brand reinforcement via a Human Interactive Proof, or reverse Turing test; said proof comprising a method for restricting access to a computer system, resource, or network to live persons, and for preventing the execution of automated scripts via an interface intended for human interaction.

When queried for access to a protected resource, the system will respond with a challenge requiring unknown petitioners to solve a visual puzzle comprising multiple objects before proceeding.

The puzzle objects are further associated in such a way as to cause human subjects to discover a strong functional link to a prominently branded object or product, or to associate the use of said object with a favorable outcome.

The puzzle objects are assembled into a composite test image which is designed to frustrate machine interpretation but is still easily interpreted by a human being.

### CROSS-REFERENCE TO OTHER PATENTS

This application is a Continuation-in-Part of, and claims priority to co-pending U.S. patent application Ser. No. 12/66,053, entitled “System and Method for Restricting Access to a Computer System to Live Persons by Means of Semantic Association of Images”, which was filed on Jan. 29, 2010, and which is herein incorporated by reference in its entirety.

### REFERENCES

US. Patent Documents

| | | |
|---|---|---|
| 7,603,706 | October 2009 | Donnely, et al. |
| 7,606,915 | October 2009 | Calinov, et al. |
| 7,197,646 | March 2007 | Fritz, et al. |
| 7,149,899 | December 2006 | Pinkas, et al. |
| 7,139,916 | November 2006 | Billingsley, et al. |
| 6,954,862 | October 2005 | Serpa, Michael Lawrence |
| 6,240,424 | May 2001 | Hirata, Kyoji |
| 6,195,698 | February 2001 | Lillibridge, et al. |
| 12/696,053 | January 2010 | Christopher Liam Ivey |

### Other References

1. Alan Turing, “Computing Machinery and Intelligence”, Mind (journal), 1950
2. Gregg Keizer, “Spammers' bot cracks Microsoft's CAPTCHA: Bot beats Windows Live Mail's registration test 30% to 35% of the time, says Websense”, Computerworld”; February, 2008
3. Kyle VanHemert, “Advertising Captchas: Annoying Squared”, Gizmodo.com (online journal), September, 2010

### BACKGROUND OF THE INVENTION

### The Problem

In his 1950 paper Computing Machinery and Intelligence', Alan Turing proposed his now famous test, in which a computer is said to be thinking if it can win a game in which a human judge attempts to distinguish between human and mechanical interlocutors.

However, over time it has become apparent that the inverse of that question has become more pressing: can a machine distinguish between human operators and other machines?

The reason for this is that commercial and social networking applications on the Internet are becoming increasingly plagued by unscrupulous marketers, and opportunists who use software to exploit interfaces intended for human users to flood websites, online forums and mail servers with unsolicited marketing—or worse yet, by criminals who exploit weaknesses in human interfaces to capture data for fraudulent purposes.

If a person is limited to interacting with a computer system by physically typing requests, the amount of data he can gather, and the amount of damage he can do is limited; but with the aid of malicious software, a single operator can flood a network with millions of spam messages, or make thousands of requests for data in just a few seconds.

It turns out that limiting human interfaces to human operators is a critical task, and a substantial amount of intellectual property has been devoted to this problem—especially in the past few years. The so-called “Reverse Turing Test” has become an important problem for software developers.

The problem is that none of the current technologies are completely effective. Automated programs created by spammers have proven to be as much as 35%² effective when deployed against commercial solutions like Microsoft's Live Mail and Google's Gmail service.

Most of the research so far has focused on the mechanical aspects of how human beings recognize images, and a lot of effort has gone into discovering ways to distort images so they are still human-recognizable, but are computationally expensive for machines to resolve.

The standard “Captcha”, or reverse Turing test uses a sequence of glyphs, (letters and numbers), that have been run together, or warped, or have lines drawn through them, or have otherwise been altered to make them difficult to isolate and classify.

For their part, spam marketers and other agents who want to break live person verification systems have been developing technology to break down the job of recognition into three steps: preprocessing and noise reduction; segmentation; and classification.

The problem with using simple glyphs like letters and numbers is that there aren't many of them that are in regular use by humans, (for practical purposes they're pretty much limited to the characters on a typical computer keyboard), and in order to be recognizable at all, they must obey basic rules with regard to silhouette. This means that if you distort the glyphs enough that they can't readily be classified with software, human readers likely won't be able to recognize them either.

Some developers have attempted to use shape or image recognition instead of glyphs as a reverse Turing test. For example, Microsoft's Asirra uses a database of pet images provided in partnership by Petfinder.com. Users are asked to separate cats from dogs in a list of photographs.

Here again, there's a problem. Spam marketers who wish to break image recognition tests have demonstrated that they can simply enlist human agents to collect and classify images from very large databases in a surprisingly short time. From that point on, it's simply a matter of digital “grunt work” to compare known images with those presented by a reverse Turning test. This is the kind of work that computers excel at.

Systems that use shape recognition as a reverse Turing test can be broken by a similar process and with even less effort, since you generally have to use a restricted range of simple silhouettes that won't confuse human users.

The fact is, computers have become so powerful and inexpensive that you can't rely on computational expense to protect computer networks from machine agents.

An Epistemological Approach

Curiously, most of the research I have read in this field is related to the mechanical process of how people see—how they isolate shapes from the background, and segment them into individual objects.

There seems to be a surprising lack of epistemological curiosity as to how it is that humans know what a thing is once they have perceived it. Machines can be trained to perceive things. For many academics jury is still out as to whether they can ever know things.

For my part, I don't believe they can. A computer is a remarkably simple machine that inhabits an entirely pragmatic and platonic universe: it can only recognize a thing by comparing it against the same thing. Otherwise, it can only compare similarities.

You can use a machine to compare apples to oranges, but to a computer, an apple can only be said to be an apple if it's the same apple you started with. Only human beings can encompass the idea of an apple.

In other words, human beings recognize objects as ideas. More importantly, they can just as quickly grasp a whole host of associations between ideas that are unpredictable, in some cases illogical—and always human.

It is these semantic associations that tell us, for example, that a shabby, comfortable chair belongs at a cheerful fireside, while a sleek plastic office chair does not.

I believe that in the long run, the only truly successful test for a human presence on a computer system requires that we exploit the semantic and symbolic associations that a human being can make—and will always try to make in any random collection of objects; and that a machine by definition can not.

To be successful, a reverse Turing test can only be composed or created by a human agent, although it can be administered by a machine.

The Proposed Test

What I propose in this invention is a system where a computer will assemble a visual test out of associations created in advance by human operators. Essentially, there are two variations on the test: one is to find two or more objects in an apparently random collection that should go together. In the other variation, the subject has to find the object that doesn't belong—much like the old association game on the PBS television program, Sesame Street.

Because of the arbitrary fashion in which humans associate things, a relatively small database of images can result in thousands of matches—often incorporating the same objects in different ways. For example, consider the following objects: dog, boy, steak, frying pan, fish, baseball bat, baseball, table, and chair.

The dog is compatible with the boy, the ball, the steak, and possibly the fish, but not the table or the frying pan. The steak and the fish are compatible with the frying pan, and possibly the table, but the table is more compatible with the chair.

Humans will naturally link images that have the strongest functional association, so if they are asked to match the table with any of the other objects, they will almost always choose the chair. After all, you almost always sit on a chair when at a table—but the steak and the fish or confusing. A human being will cast about looking for a plate and possibly a knife and fork.

This is because humans instinctively organize objects in collections. A machine has no way of making the arbitrary associations that allow humans to collect objects that often have no immediate and discernible qualities in common.

Subtle differences in objects can affect their association as well. It makes sense to associate a boy and his dog, but it makes more sense to the person taking the test if the dog is a beagle than it does if the dog is a pit bull terrier.

How it would Work

We can create a test that can be assembled and administered by a machine, but only if the essential semantic associations that it is based on are first created by human operators. The test would be assembled from photo objects, each of which would be associated with metadata recorded by human operators.

Semantically, we tend to classify objects in three ways: qualitatively, or in terms of its own properties, (is it soft, or hard, or shiny?); functionally, or in terms of what it does; and in terms of its emotive context, (how does it make you feel?).

Each image would be represented in a database with three sets of metadata which would consist of tags describing the emotive, qualitative, and functional properties of the object with keywords. And—this is the important part—the metadata would have to be created by human operators who would describe the objects in the images in human terms.

To further help in creating associations, each noun used to describe a photo object would be linked to other nouns using a language-like syntax of verb associations to contain objects in sets, (noun HAS noun), supersets (noun IS noun), functional associations (noun CAN verb), and direct object to object associations (noun DOES noun).

To give a practical example, sample associations for the word “candle” might be: candle HAS wick, candle IS light source, candle CAN light, candle DOES candlestick.

The test could then be assembled by an artificial intelligence methodology that simply weighted sets of images based on the correspondence of metadata in each of the three categories, or more directly by exploiting functional noun to noun links in the metadata.

The test would be effectively tunable in terms of “fuzziness”, (based on the broadness of the correspondence of keywords over the categories), and difficulty, (by simply forcing users to differentiate between matches where there are points of correspondence between all of the images).

Mechanical Improvements

Naturally, I have given thought to increasing the computational expense of collecting photo objects from the test and trying to re-create the relationships that are used in the test. In this case, I believe that the advantage lies with the agency administering the test rather than those who try to break it.

This is because they can only program computers to recognize the specific photo objects they encounter. They will need to employ human effort to associate the images and rebuild relationships, which is far more difficult in a fluid system than merely collecting images, especially since they can only solve for relationships amongst images they have already encountered, (which means the reverse-engineer effort is not easily distributable).

However, there is a very simple way to make it prohibitively difficult to collect and extract the photo objects used in any given collection: to do this, they would be overlaid on a photo background with a busy texture, using a soft edge and random variations in rotation and scaling. Once all of the images are assembled, the resulting composite would have a randomly modulated blend texture applied to it. The blend texture would be a regular shape repeated at random intervals and positions, and blended using a variety of additive, multiply or subtractive methods with a varying, low alpha.

Since photo objects are inherently more complex than glyphs, less distortion is required in order to render them useless for comparison and classification, yet is possible to subject them to more distortion and to completely change their orientation while they still remain recognizable. Because of this, the resulting image would still be highly recognizable to humans, but not easily compared to other instances of the same thing.

Reverse Turing Tests as a Platform for Brand Reinforcement

Hitherto, we have only discussed a basic embodiment of a reverse Turing test that exploits the semantic links humans intuit between images, as claimed by the inventor in US application Ser. No. 12/696,053.

However, this unique approach of exploiting semantic links presents an ideal opportunity for fulfilling an additional purpose, which is the reinforcement of brand identity.

In an attempt to monetize and commercialize Human Interactive Proof or reverse Turing test applications, developers have explored a variety of dual purpose technologies, including using the subject of the test as a “mechanical Turk” or crowdsource worker to complete simple tasks—such as solving scanned text that OCR software can't interpret. Many have turned to one scheme or another for including advertising as part of a reverse Turing test.

Generating advertising revenue seems to be the simplest and most direct way to monetize a reverse Turing test, but there are couple of serious problems with this.

First of all, it's annoying to consumers to encounter what is essentially spam on an application designed to prevent spam. This is especially true given the fact that the majority of CAPTCHAs and similar tests are regarded as frustrating to use in the first place. The online technology publication Gizmodo described the product that results as “Annoying Squared”³.

Perception is important. If your goal is to reassure users that you are protecting your tools and application from spam and unwanted advertising, you can't risk undermining that perception by forcing your users to interact with advertising content over which you have no control.

The second problem with using reverse Turing tests as a platform for advertising is that advertisers generally don't want their images or advertising message to be distorted or obfuscated. This means advertising CAPTCHAs tend to be even less effective at preventing spam than most competing technologies.

However, there is a strong case to be made for capitalizing on a situation where users are required to concentrate on a puzzle or test. It's simply necessary to do this in a way that doesn't compromise the effectiveness of the application and in a way that is not perceived by users as exploitative.

What I propose with this invention is method of using a reverse Turing test as a platform for brand reinforcement. A test that requires users to make semantic or functional links between images of objects is an ideal mechanism to do this—all you have to do is generate puzzles or tests that require you users to associate a branded object with a functionally linked object or situation.

For example, if the user is required to solve a puzzle where roasted coffee beans are meant to be matched with a cup of coffee, there's no reason why it couldn't be a cup of Starbuck's® coffee with the logo prominently displayed. This simple mechanism could be used to reinforce the brand functionality of virtually any household product: a white smile needs Crest® toothpaste; dirty socks would require the services of Tide® laundry detergent; Finish® dishwasher detergent results in sparkling clean glassware . . . .

All that is required to make the system work in this context is a mechanism for substituting a branded product for a generic image object, and a means of tracking and managing campaigns.

From the user's perspective, the system is completely transparent. Even though we are presenting them with a test that requires them to intuit a semantic association between a brand and its application, outcome, or context, the process of completing a branded test is no different than it would be for an unbranded test. It remains equally simple to complete, and the brand presentation takes place at much less liminal level than it would in the context of a traditional ad.

In most cases, the user would simply remain unaware that they have been presented with a brand proposition.

It's important to note that this is a system and method or brand reinforcement—not for advertising. In a traditional ad context, there is an overt message, a call to action, and additional information as to how to get the product and how much it costs. For example an ad for soda might read: “Belch's soda tastes great when you're thirsty! Only $3.99 a case. Buy it at your local grocer's”. In this case there's a clear message, (Belch's soda tastes great), a call to action, (buy it at your grocer's), and an appeal based on price, ($3.99 a case).

The invention I'm proposing here simply can't provide the same functionality without losing its perceived integrity as an anti-spam application. There can be no call to action, no overt message, and no straightforward metrics based on click-through.

What this invention does is quietly reinforce brand. In aggregate, this can be very effective. If, over the course of a two week campaign you require a million users to literally connect Dawn® dish detergent with sparkling clean dishes you will have made a very compelling argument for using Dawn® detergent instead of another brand. What you've done is train an aggregate population that Dawn® is the choice they should make if they want clean dishes.

Extending the Embodiment to Audio Tests for the Visually Impaired

In the invention claimed in US application Ser. No. 12/696,053, I chose not to address the need for an audio-based version of the test, citing the difficulty of protecting the integrity of the technology while generating audio tests that were easy for users to complete.

However, it has emerged that it is, in fact possible to do this, and in so doing, to produce reverse Turing tests that are more accessible and comprehensible to the visually impaired than any other technology in common use.

There are some patents that deal with using audio cues to administer a reverse Turing test. Some involve identifying spoken letters and numbers, and one proposal suggests requiring users to type in rhythm with an audio cue.

By extension, you could require test subjects to identify and associate audio cues. With a little imagination, one can easily see how, for example, a human might associate the melody from “Happy Birthday” with the sound of children laughing, or the sound of tissue paper tearing.

Humans also have an innate ability to recognize melodic structure, so a similar test might involve matching snippets of the same melody recorded a cappella or using different instruments.

However, there are two problems with using audio cues in a reverse Turing test. The first is that audio cues are very easy to collect and match by mechanical means, and humans are far more easily confused by alterations in sound than machines. Reversing an audio clip wouldn't disguise it from an audio matching program, but would make it unrecognizable to most humans.

The second problem is simply one of convenience. Most sighted persons primarily interact with computers in a visual manner. They often have their audio turned off, or if not, they're just often listening to music or voice recordings while they work.

Most people would consider it an inconvenience to have to turn off their music or turn up their speakers in order to take a test in order to access a resource.

There is still a valid case to be made for developing a reliable reverse Turing test for blind persons that uses audio cues—so long as the test remains secure and simple to complete. By means of semantic associations, we can accomplish pretty much the same thing with spoken words as we can by matching images. Instead of requiring users to draw a line matching two or more images, we would simply record a label for each object as a spoken word, and require users to type in the word or words they feel represent the best match for the keyword.

To help prevent the use of audio harvesting and waveform matching, we would superimpose a randomly selected waveform of a sound that may or may not comprise a rhythmic or melodic structure.

The resulting test would still be easier to complete than most current audio based reverse Turing tests, because we would not be compelled to disguise the spoken words to the same extent. In fact, by simply generating a test that doesn't include the solution in the test, we would be able to create tests where the audio doesn't need to be disguised at all.

After all, the test does not consist of merely recognizing words, but rather of making a semantic association between a plurality of words, and the whole point of accessibility is to make interacting with computers easier for the visually impaired—not more difficult.

### SUMMARY OF THE INVENTION

The invention is a system and method for delivering brand reinforcement as a component of a Human Interactive Proof, (also called a reverse Turing test).

A Human Interactive Proof is a system and method for restricting access to a computer system, resource, or network to live persons, and for preventing the execution of automated scripts via an interface intended for human interaction. The invention will provide the functionality of a Human Interactive Proof, while simultaneously reinforcing consumer awareness of any brand or product introduced into the system.

When queried for access to a protected resource, computer system, or network, the system will respond with a challenge requiring unknown petitioners to solve a visual puzzle before proceeding, said puzzle consisting of a collection of apparently random objects.

The subject of the test must either recognize a semantic or symbolic association between two or more objects, or isolate an object that does not belong with the others, indicating their selection with the pointing device on their local computer.

If the subject of the test succeeds in passing the test, they are granted access to the requested resource, computer system, or network. If not, they are invited to attempt the test again, up to a configurable maximum retests, after which time their request is simply ignored.

The system is configurable in such a way that the objects introduced into the puzzle may prominently feature a brand mark or manufacturer's name. The subject of the test would be required to form an association of the product and its purpose, or of the product and a desirable outcome of using the product.

In this way, the invention will reinforce consumer awareness of the brand while at the same time determining whether or not the subject of the test is a human or a machine intelligence.

In the drawings, which form a part of this specification,

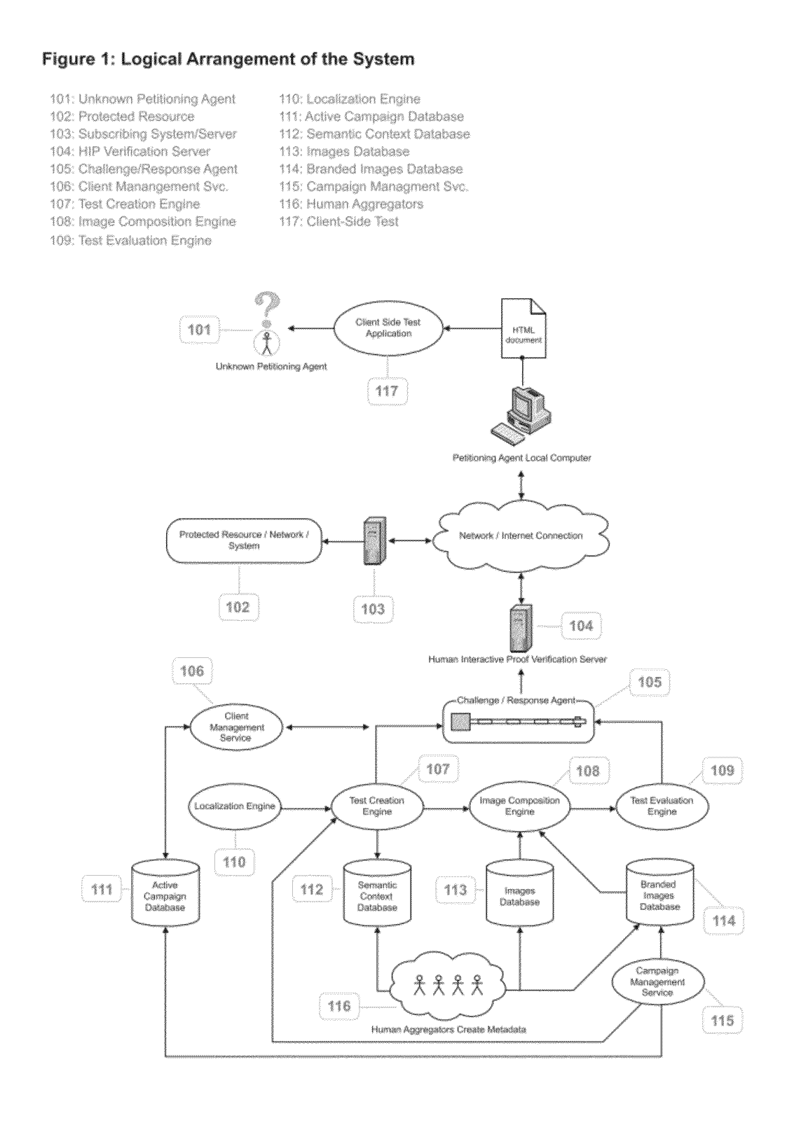

FIG. 1 is a logical diagram showing the system for challenging and testing unknown petitioners for access to a protected resource while reinforcing brand identity; and

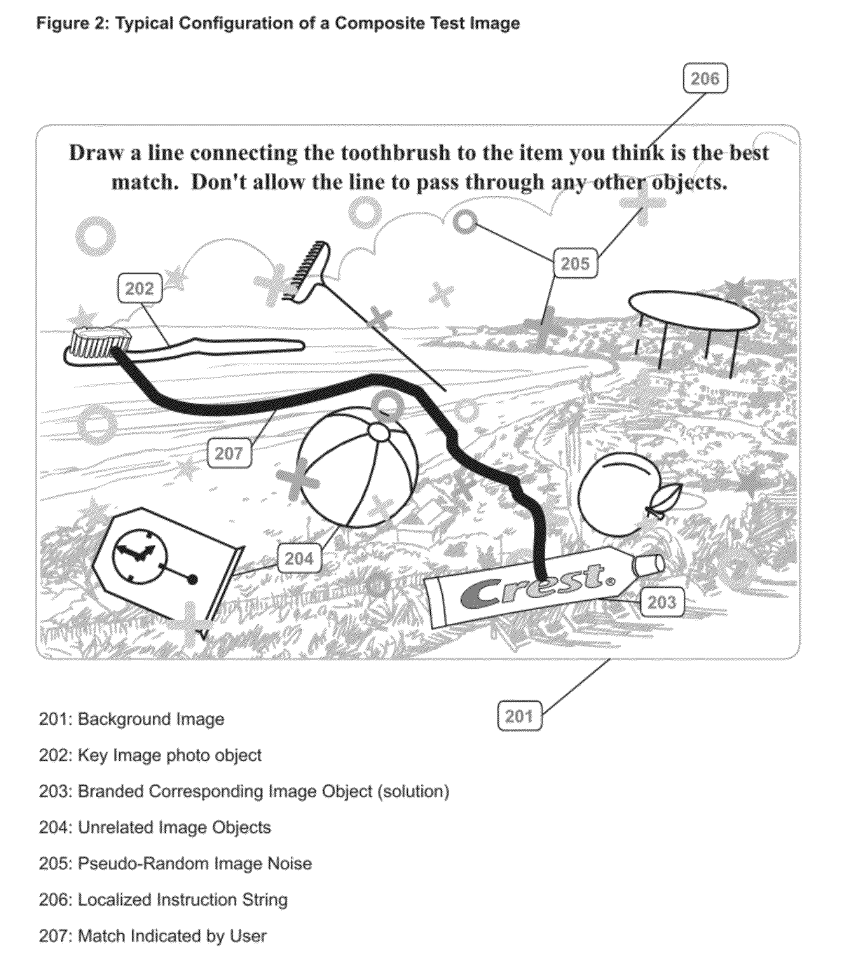

FIG. 2 shows the layout of a composite test image as generated by the system.

### DETAILED DESCRIPTION OF THE INVENTION

The invention is a system and method for delivering brand reinforcement while simultaneously restricting access to a computer system, resource, or network to live persons, and by extension for preventing the execution of automated scripts via an interface intended for human interaction.

In other words, it's a system to prevent spammers and malicious coders from exploiting web forms or information request pages that are intended for use by humans, and it does so in a way that forces users to associate brand marks with a function or with a favorable outcome.

As shown in FIG. 1, the system is resident on a plurality of servers connected to the Internet, and is available to organizations and entities which subscribe to the service [103] as a means of restricting access via the Internet to applications, services and resources that are resident on their own local computer systems, servers, and networks [102].

A Semantic Context Database [112] is created to correspond to an arbitrary collection of photo objects, (images in which a single object has been isolated against a transparent background), which are stored in an Images Database [113]. A similar Branded Images database is used to store campaign images that feature objects with prominent brand marks [114]. Each entry in the Semantic Context Database must be created and aggregated by human operators [116].

Each image in the Images Database is identified with a unique ID, and associated with a corresponding metadata entity in the Semantic Context Database that describes the image qualitatively, functionally, and emotively.

Semantic metadata for both branded and unbranded images is stored in the Semantic Context Database, but the metadata for branded images also includes a campaign identifier.

When a request is made by an unknown agent [101] to access a protected resource [102], that resides on a computer system or server that subscribes to the service [103], a challenge request is sent to a Human Interactive Proof Verification Server [104].

The Human Interactive Proof Verification Server invokes the Challenge/Response Agent [105] which creates a session for the Petitioning Agent's computer, and then invokes the Client Management Service [106].

The Client Management Service is used to keep track of all systems and entities that subscribe to the service, and references the Active Campaign Database [111], which lists all of the current active campaigns and cross-references them with all of the current subscribing systems and servers, allowing the Client Management Service to determine which marketing campaigns they are eligible to participate in. The Client Management Service will select an appropriate campaign, and then in turn invoke the Campaign Management Service [115].

Based on whether or not the subscribing entity is participating in an ongoing campaign, the Campaign Management Service will select an appropriate image from the Branded Images Database [114] to use in generating a challenge as a Human Interactive Proof.

The Campaign Management Service in turn invokes the Test Creation Engine [107] to create a reverse Turing test for the session. In practice, of course, the Petitioning Agent [101] may or may not turn out to be a human user.

The Test Creation Engine will then randomly determine the test type, which can either be associative or exclusive. An associative test requires the Unknown Petitioning Agent to identify an object in a collection, and then select another object in the collection that they feel semantically is the best match to the first object. An exclusive test requires the Unknown Petitioning Agent to identify the object they feel has the least in common with the other objects in a collection.

If the test type is determined to be exclusive, the Test Creation Engine will use the image ID provided by the Campaign Management Service as the Key Image for the test. If the test is associative, the image provided by the Campaign Management Service will be randomly determined to be either the Key Image, or the Solution for the test.

If the test is associative, the Test Creation Engine will first query the Semantic Context Database for the ID of an image which has associated metadata that closely corresponds to that of the image provided by the Campaign Management Service in one or more metadata categories.

Each image object is associated with metadata entities, (or “tags”), that describe the object qualitatively, functionally, emotively, and by context. Each of these entities is in turn linked to other entities using a language-like syntax that organizes them into supersets; into subsets; by function; and by direct noun to noun interaction. Each object can inherit a whole host of associations by being linked to only a few metadata entities. Two objects are said to have a “high correspondence” if they share a lot of the same metadata entities, and a “low correspondence” if they don't.

The number of points of correspondence and the number of categories of correspondence required to link objects for the purpose of a test are configurable to allow a system administrator to modify the difficulty of the test.

At this point, the Test Creation Engine will have the unique IDs of two photo objects that a human being would be likely to associate as being related. The Test Creation Engine will then query the Semantic Context Database for a collection of image IDs which have associated metadata which has very few points of correspondence with the representative metadata for the Key image. The number of additional images and the number of points of correspondence are configurable to allow a system administrator to modify the difficulty of the test.

If the test is exclusive, the Test Creation Engine will first query the Semantic Context Database for the unique IDs of a collection of multiple images which have associated metadata that closely corresponds to that of the image provided by the Campaign Management Service in one or more metadata categories. The number of points of correspondence and the number of categories are configurable to allow a system administrator to modify the difficulty of the test.

At this point, the Test Creation Engine will have the unique IDs of a collection of photo objects that a human being would likely associate as being related. The Test Creation Engine will then query the Semantic Context Database for a single image which has very few points of correspondence with the representative metadata for the Key Image. The number of points of correspondence are configurable to allow a system administrator to modify the difficulty of the test.

The Test Creation Engine will then pass the ID of the Key Image, the IDs of the other images, and the test type, (associative or exclusive) to the Challenge/Response Agent, (which would have stored the language preferences of the user as part of the session data).

The Challenge/Response Agent would then invoke the Localization Engine [110] to create an instruction string for the user. In the case of an associative test, the string would name the Key Image in the test and instruct the user to find the matching item. In the case of an exclusive test it would instruct the user to find the object that doesn't belong.

The Challenge/Response Agent will then invoke the Image Composition Engine [108], and pass it the IDs of the images to be used in the test, together with the localized instruction string.

The Image Composition Engine will use these IDs to create a composite image designed to frustrate machine interpretation. As shown in FIG. 2, the Image Composition Engine will first select a random background image [201] from the Images Database. The background image will have been selected as a good candidate for the purpose, and will feature a strong pattern or random noise. The Image Composition Engine will then request all of the test images [202-204] from the Images Database, and position them at random positions on top of the background image.

The position of the test images can be completely random, so long as they are completely contained within the confines of the background image, and do not overlap. Each test image will have a slight degree of random scaling and rotation applied to it. In some cases, the UV coordinates, (the internal coordinates stored in the binary data representing the pixels in the image), of the test images may be inverted prior to rotation in order to flip the image. Each test image will also be alpha blended against the background image by a small random amount in order to make segmentation of the photo object more difficult for a machine process.

All of the parameters used by the Image Composition Engine are configurable in order to allow a system administrator to modify the difficulty of the test.

In one possible embodiment of the invention, once all of the test photo objects are assembled on the background image, a special noise pattern is created and applied to the entire composite image [205]. The blending noise is created by generating a collection of several small, but regular shapes—like plus signs, circles, and squares—and positioning them randomly on the composite image. Each shape would have a slightly different colour value, and it would be blended at a low alpha value by multiplying, adding or subtracting the colour value from the underlying pixels. The blend mode used and the alpha value at which it is applied would be random for each shape instance.

The resulting noise would be easily dismissed by a human viewer, but it would greatly complicate the process of isolating photo objects in the scene for a machine process. This process increases the security of the rendered test and helps to prevent image harvesting, but it may not be present in all embodiments of the invention.

Last of all, the Image Composition Engine would render the text in the instruction string [206], and superimpose it on a space reserved either at the top or the bottom of the composite test image.

The Image Composition Engine will also create an image map corresponding to the composite test image that would track the position of the Key image and of the other test images. Once the composite test image and the image map are created, the Image Composition Engine will pass them to the Challenge/Response Agent.

Once the test is assembled, and the test image is created, the Challenge/Response agent will transmit the test image to the Subscribing System or Server [103], which in turn would display the image as part of a small Client-Side Test Application [117] on the Petitioning Agent's computer. The client-side application can be delivered as part of an HTML document, and can be implemented using any of a variety of common client-side application technologies, including AJAX, Java, Flash, or the Silverlight framework. The client/server communications for the challenge and the test do not require encryption.

The Client-Side Test Application will display the test image and instruct the Petitioning Agent to use their pointing device complete the test. The rest of the instructions are embedded in the instruction string which is superimposed on the test image.

If the Petitioning Agent turns out to be a human user, they can simply use their mouse or pointing device to draw a line connecting the key image object with its match [207], (if the test is associative), or to draw a circle around the one image object that doesn't belong with the others, (if the test is exclusive). In either case, the Unknown Petitioning Agent would be required to draw a line with their mouse or pointing device. Merely requiring them to click on an object would not provide adequate security for the system.

The Client-Side Test Application will listen for a press event from the pointing device on the Unknown Petitioning Agent's computer. On press, (whether it is a button event on a mouse or a pressure event on a stylus or touch screen), the Client-Side Test Application will start recording the position of the pointing device every few milliseconds.

Once the Unknown Petitioning Agent or user releases the mouse button or otherwise generates a release event for the pointing device, the Client-Side Test Application will stop recording the position of the pointing device, and will transmit the collected path data to the Subscribing System or Server along with any other form or application data that has been collected.

In turn, the Subscribing System or Server will transmit the collected path data to the Challenge/Response Agent.

The Challenge/Response Agent will then pass the collected data and the image map for that test to the Test Evaluation Engine [109]. The Test Evaluation Engine will compare the pointing device position data to the image map.

In the case of an associative test, it will look for the start and end points of the line created by the pointing device, and check to see if they correspond to the position of the key image and the matching image. The Test Evaluation Engine will also check to see if the line created by the pointing device intersects any images that are unrelated to the key image. Failure on either of these two conditions would constitute a failure of the test.

In the case of an exclusive test, the Test Evaluation Engine will check to see if the line created by the pointing device encloses the area occupied by the image that doesn't belong with the others. It will also verify that the line created by the pointing device does not enclose any of the other photo objects in the test image. Failure on either of these two conditions would constitute a failure of the test.

Once it has evaluated the test data, the Test Evaluation Engine will pass the test results back to the Challenge/Response Agent which in turn would provide a response to the Subscribing System or Server as either a pass or fail condition.

If the Petitioning Agent has passed the test, the Subscribing System or Server would allow the Petitioning Agent access to the requested resource. If not, it will return a message advising the Petitioning Agent of the failure.

In the case of a failure, the Petitioning Agent will be given the opportunity to take the test again, up to a maximum number of retests, which would be configurable by an administrator of the system.

The embodiments of the invention in which an exclusive property or privilege is claimed are defined as follows:

1. A system for restricting access to a computer system, resource, or network to live persons, and for preventing the execution of automated scripts via an interface intended for human interaction by means of a reverse Turing test that exploits the semantic, symbolic, and contextual associations humans instinctively form between objects, and which links these associations with products and brand marks in the context of function or favorable outcome; the system comprising:
a) A computer system, resource, or network on which protected applications or data are resident, herein described as a Subscribing System or Server;
b) A Challenge/Response Agent, comprising a storage medium containing machine readable instructions which are executable by a computing platform and resident on a server; said Agent creating and managing a session each time a protected resource is requested by an unknown Petitioning Agent, and which allows or denies access to the requested resource, system, or network based on the outcome of a test designed to determine whether or not the Petitioning Agent is a human user;
c) A Client Management Service, comprising a storage medium containing machine readable instructions which are executable by a computing platform, said Service being responsible for matching a Subscribing System or Server with appropriate branded campaign content;
d) An apparatus comprising non-volatile memory containing an Active Campaigns Database cross-referencing branding campaign content with Subscribing Systems or Servers;
e) A Test Creation Engine, comprising a storage medium containing machine readable instructions which are executable by a computing platform, said Engine creating a unique test for each verification session, based on a combination of configurable and random parameters;
f) An apparatus comprising non-volatile memory containing an Images Database containing a plurality of random images;
g) An apparatus comprising non-volatile memory containing a Semantic Context Database, containing a plurality of metadata associated with the unique ID of each image in the Images Database;
h) An apparatus comprising non-volatile memory containing an Branded Images Database containing a plurality of product images which feature prominent brand marks;
i) A Localization Engine, comprising a storage medium containing machine readable instructions which are executable by a computing platform, said Engine creating a localized instruction string to guide the Petitioning Agent in completing the test;
j) An Image Composition Engine, comprising a storage medium containing machine readable instructions which are executable by a computing platform, said Engine composing the images selected for a test into a single composite image, based on a combination of configurable and random parameters;
k) A Campaign Management Service, comprising a storage medium containing machine readable instructions which are executable by a computing platform, said Service being employed to select appropriate branded images for inclusion in a test;
l) A Client-Side Test Application, comprising machine readable instructions which are executable by a computing platform which is executed on the local computer of the Petitioning Agent;
m) A Test Evaluation Engine, comprising a storage medium containing machine readable instructions which are executable by a computing platform, which examines the results returned by the Client-Side Test Application, and returns a pass or fail result to the Challenge/Response Agent.

2. A system according to claim 1, whereby the Challenge/Response Agent will respond to any request from an unknown Petitioning Agent for a protected resource, system or network by creating a test session and invoking the Client Management Service.

3. A system according to claim 1, whereby the Client Management Service will consult the Active Campaigns Database in order to select an appropriate branding campaign for application to the test generated by the system.

4. A system according to claim 1, whereby the Client Management Service will in turn invoke the Campaign Management Service to select an appropriate image ID from the Branded Images Database to be used as the key image in generating a test.

5. A system according to claim 1, whereby the Campaign Management Service will then invoke the Test Creation Engine, and pass it the key image ID to be used in generating a test.

6. A system according to claim 1, whereby the Test Creation Engine will instantiate a new test which is randomly determined to be of either associative or exclusive logic.

7. A system according to claim 1, whereby if the test is associative the Test Creation Engine will query the Semantic Context Database for a collection consisting of the ID of a single image that is semantically associated with the key image and a plurality of image IDs that are not semantically associated; and if the test is exclusive, the Test Creation Engine will query the Semantic Context Database for a collection consisting of the IDs of a plurality of images that are not semantically associated with the key image.

8. A system according to claim 1, whereby the Test Creation Engine will query the Localization Engine for a translated instruction string that will guide the user to draw a line joining the key image to an image that is semantically associated with it, (if the test is an associative test), or to circle the image that doesn't belong, (if the test is an exclusive test).

9. A system according to claim 1, wherein the Test Creation Engine will pass the collection of image IDs and the localized instruction string to the Image Composition Engine, which will in turn create a composite test image.

10. A system according to claim 9, whereby the Image Composition Engine will Query the Images Database for the images associated with a collection of image IDs, and query the Branded Images Database for the image associated with the key image ID and assemble them into a single composite test image; and render the localized instruction string on top of the composite test image.

11. A system according to claim 9, whereby the Image Composition Engine will create an image map that corresponds to the placement of the individual images contained in the composite test image.

12. A system according to claim 1, whereby the Challenge/Response Agent will transmit the composite test image to a Client-Side Test application, which can be embedded in an HTML document and is executed on the local computer of the Petitioning Agent.

13. A system according to claim 1, whereby the Client-Side Test application will instruct the Petitioning Agent to use the pointing device on their local computer to complete the instructions embedded in the composite test image.

14. A system according to claim 12, whereby the Client Side Test application will start recording the position of the pointing device on the Petitioning Agent's local computer at intervals of a few milliseconds when it receives a press event from the pointing device, and will stop recording and transmit the collected position data back to the Challenge/Response agent when it receives a release event from the pointing device.

15. A system according to claim 1, wherein the Challenge/Response Agent passes the test data to the Test Evaluation Engine, which will plot the position data collected for the pointing device on the Petitioning Agent's computer, and compare it to positions of the separate test sub images as recorded in the image map corresponding to the composite test image.

16. A system according to claim 15, wherein if the test is an associative test, the Test Evaluation Engine will return a pass result if the pointing device position data forms a line connecting the key image with the associated image without intersecting any of the other sub images in the composite test image; and if the test is an exclusive test, the Test Evaluation Engine will return a pass result if the pointing device position data forms a line that intersects or encloses the key image without enclosing or intersecting any of the other sub images in the composite test image; if the pass condition is not met, the Test Evaluation will return a failure result.

17. A system according to claim 1, whereby if the Test Evaluation Engine returns a pass result, the Challenge/Response Agent will instruct the Subscribing Server or System to allow the Petitioning Agent access to the requested computer system, resource, or network; and if it returns a failure result, the Challenge/Response Agent will transmit a failure notification to the Petitioning Agent.

18. A system according to claim 1, wherein if the Petitioning Agent fails to pass a test, the Challenge/Response Agent will allow the Petitioning Agent to request a new test, up to a maximum number of retests; after which, the Challenge/Response Agent will simply refuse all requests from the Petitioning Agent for the duration of cool-down time; the maximum number of retests and cool-down interval being configurable by an administrator of the system.

19. A method for associating Subscribing Systems or Servers with branding campaigns in such a way that each Subscribing System or Server may or may not be served Human Interactive Proofs that feature prominently branded products or objects, and that the branded products or objects that do appear are deemed appropriate and in character with any products or services featured on any public website maintained by the subscriber.

20. A method for recording and retrieving the semantic, and symbolic associations human beings make between images of objects, and linking these associations with products and brand marks in the context of function or favorable outcome; said method comprising the creation of metadata consisting of a plurality of words and phrases which describe each image qualitatively, (or in terms of appearance and other qualities); functionally, (or in terms of use and purpose and taxonomy); and emotively, (or in terms of emotional state affected in the viewer); said metadata being created and collected for each image in a collection by human operators.
